(19) United States
(12) Patent Application Publication
(10) Pub. No.: US 2019/0152268 A1
(43) Pub. Date: May 23, 2019

(54) PNEUMATIC TIRE

(71) Applicant: TOYO TIRE & RUBBER CO., LTD., Itami-shi (JP)

(72) Inventor: Toshihiko Kanamura, Itami-shi (JP)

(73) Assignee: TOYO TIRE & RUBBER CO., LTD., Itami-shi (JP)

(21) Appl. No.: 16/168,313

(22) Filed: Oct. 23, 2018

(30) Foreign Application Priority Data
Nov. 17, 2017 (JP) 2017-221729

(51) Int. Cl. B60C 11/03; B60C 11/00

(52) U.S. Cl. CPC B60C 11/033; B60C 11/0008; B60C 11/0304; B60C 11/0306; B60C 2011/0388; B60C 2011/0334; B60C 2011/0341; B60C 2011/0358; B60C 2011/0025

(57) ABSTRACT

A pneumatic tire includes a tread region having surface layer containing a tread surface that contacts the ground, and a sidewall region having an indicator region that indicates a vehicle mounting direction, the surface layer is formed from rubber having a rebound resilience that, is 35% to 40%, the tread region comprises a plurality of main grooves that extend in a tire circumferential direction, total area of that portion of the main grooves which is or are arranged to an inboard side of a center in a tire width direction of the tire as it is to be mounted on a vehicle is greater than total area of that portion of the main grooves which is or are arranged to an outboard side of the center in the tire width direction of the tire as it is to be mounted on the vehicle.

### CROSS REFERENCE TO RELATED APPLICATIONS

This application claims the benefit of priority of Japanese application no. 2017-221729, filed on Nov. 17, 2017, which is incorporated herein by reference.

### BACKGROUND OF THE INVENTION

### Field of the Invention

The present invention relates to a pneumatic tire.

### Description of the Related Art

Conventionally known as a pneumatic tire for reduction of rolling resistance is a pneumatic tire formed from prescribed rubber (e.g., Japanese Patent Application Publication Kokai No. 2016-193687). It so happens that when a pneumatic tire is mounted on a vehicle in such fashion as to have negative camber, because ground contact length (length in the tire circumferential direction of the ground contact) at locations toward the inboard side of the mounted tire will be greater than ground contact length at locations toward the outboard side of the mounted tire, there will be a tendency for water to accumulate at locations toward the inboard side of the mounted tire.

To address this, the pneumatic tire associated with Japanese Patent Application Publication Kokai No. 2016-193687 is such that the void ratio at shoulder regions is greater than the void ratio at a center region. But as this increases the tendency for water to accumulate at locations toward the inboard side of the mounted tire, it causes a decrease in anti-hydroplaning performance (i.e., decreased ability to suppress occurrence of the phenomenon of hydroplaning).

### SUMMARY OF THE INVENTION

The problem is therefore to provide a pneumatic tire making it possible to suppress decrease in anti-hydroplaning performance while simultaneously employing rubber(s) causing reduction in rolling resistance.

There is provided a pneumatic tire, which includes:

a tread region having surface layer containing a tread surface that contacts the ground; and

a sidewall region having an indicator region that indicates a vehicle mounting direction;

wherein the surface layer is formed from rubber having a rebound resilience that is 35% to 40%;

wherein the tread region comprises a plurality of main grooves that extend in a tire circumferential direction; and

wherein total area of that portion of the main grooves which is or are arranged to an inboard side of a center in a tire width direction of the tire as it is to be mounted on a vehicle is greater than total area of that portion of the main grooves which is or are arranged to an outboard side of the center in the tire width direction of the tire as it is to be mounted on the vehicle.

Further, the pneumatic tire may have a configuration in which:

wherein the further toward the inboard side that each of the plurality of main grooves is arranged on the tire as it is to be mounted on the vehicle the greater is the width of the each of the plurality of main grooves.

Further, the pneumatic tire may have a configuration in which:

wherein the tread region further comprises a plurality of land portions that are partitioned by the plurality of main grooves and grounding ends; and

wherein width of that one among the plurality of land portions which is arranged in outboardmost fashion on the tire as it is to be mounted on the vehicle is greater than widths of the other land portions.

Further, the pneumatic tire may have a configuration in which:

wherein the tread region further comprises a plurality of land portions that are partitioned by the plurality of main grooves and grounding ends; and

wherein width of that one among the plurality of land portions which is arranged in inboardmost fashion on the tire as it is to be mounted on the vehicle is less than widths of the other land portions.

Further, the pneumatic tire may have a configuration in which:

wherein the tread region further comprises
an inboard shoulder land portion that is partitioned by a grounding end and that one main groove among the plurality of main grooves which is arranged in inboardmost fashion on the tire as it is to be mounted on the vehicle, and
an outboard shoulder land portion that is partitioned by the grounding ends and that one main groove among the plurality of main grooves which is arranged in outboardmost fashion on the tire as it is to be mounted on the vehicle; and

wherein width of the outboard shoulder land portion is greater than width of the inboard shoulder land portion.

Further, the pneumatic tire may have a configuration in which:

wherein there are four of the main grooves; and

wherein area of the one among the plurality of land port ions which is arranged in outboardmost fashion on the tire as it is to be mounted on the vehicle is 20% to 25% of total area of all of the land portions.

Further, the pneumatic tire may have a configuration in which:

wherein there are three of the main grooves; and

wherein area of the one among the plurality of land portions which is arranged in outboardmost fashion on the tire as it is to be mounted on the vehicle is 25% to 30% of total area of all of the land portions.

Further, the pneumatic tire may have a configuration in which:

wherein there are four of the main grooves; and

wherein void ratio between a pair of grounding ends is 30% to 40%.

Further, the pneumatic tire may have a configuration in which:

wherein there are three of the main grooves; and

wherein void ratio between a pair of grounding ends is 30% to 40%.

Further, the pneumatic tire may have a configuration in which:

wherein hardness of the rubber of the surface layer is not less than 60.

As described above, excellent benefits are provided in that a pneumatic tire is made capable of suppressing decrease in anti-hydroplaning performance while simultaneously employing rubber(s) causing reduction in rolling resistance.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing the principal components of a pneumatic tire associated with same embodiment as they would exist if unwrapped so as to lie in a single plane;

FIG. 3 is a drawing showing the ground contact shape at a pneumatic tire associated with same embodiment;

FIG. 4 is a drawing showing the principal components of a pneumatic tire associated with another embodiment as they would exist if unwrapped so as to lie in a single plane;

FIG. 5 is a table showing results of evaluation of examples and comparative examples; and

FIG. 6 is a table showing results of evaluation of examples and comparative examples.

### DETAILED DESCRIPTION OF THE INVENTION

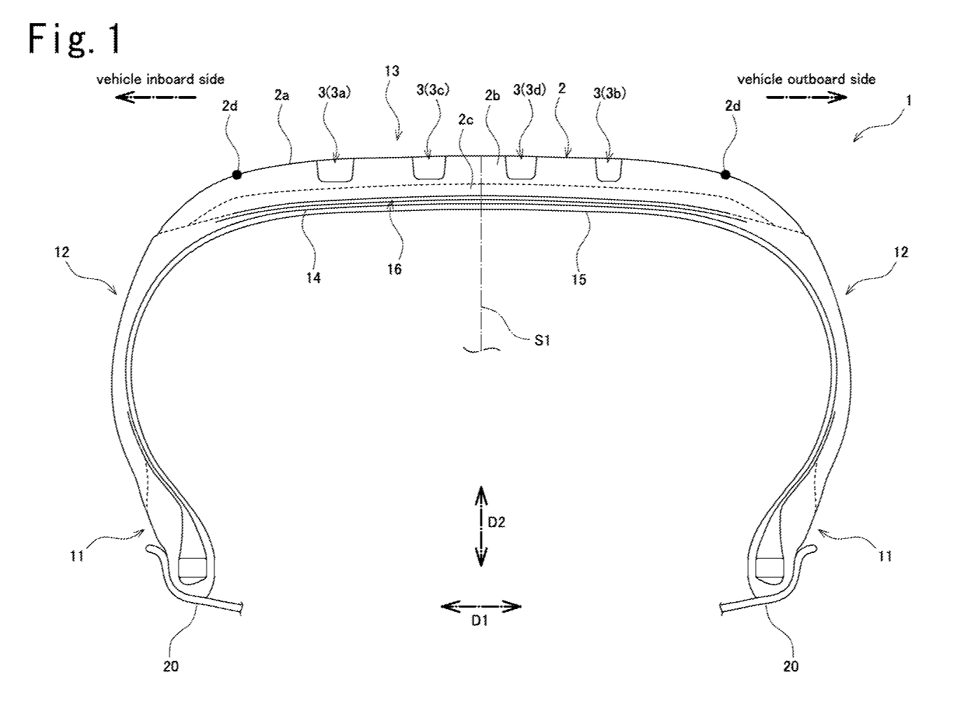

Below, an embodiment of a pneumatic tire is described with reference to FIG. 1 through FIG. 3. At the respective drawings (and the same is true for FIG. 4), note that dimensional ratios at the drawings and actual dimensional ratios are not necessarily consistent, and note further that dimensional ratios are not necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire. In addition, tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire.

As shown in FIG. 1, tire i associated with the present embodiment is provided with a pair of bead regions 11 at which beads are present; sidewall regions 12 which extend outwardly in the tire radial direction D2 from the respective bead regions 11; and tread region 13, the exterior surface in the tire radial direction D2 of which contacts the road surface and which is contiguous with the outer ends in the tire radial direction D2 of the pair of sidewall regions 12. In accordance with the present embodiment, tire 1 is a pneumatic tire 1, the interior of which is capable of being filled with air, and which is capable of being mounted on a rim 20.

Furthermore, tire 1 is provided with carcass layer 14 which spans the pair of beads, and innerliner layer 15 which is arranged at a location toward the interior from carcass layer 14 and which has superior functionality in terms of its ability to impede passage of gas therethrough so as to permit air pressure to be maintained. Carcass layer 14 and innerliner layer 15 are arranged in parallel fashion with respect to the inner circumferential surface of the tire over a portion thereof that encompasses bead regions 11, sidewall regions 12, and tread region 13.

Tread region 13 is provided with tread rubber 2 having tread surface 2a which contacts the road surface, and belt layer 16 which is arranged between tread rubber 2 and carcass layer 14. Tread rubber 2 is provided with surface layer 2b which comprises tread surface 2a, and interior layer 2c which is arranged between surface layer 2b and belt layer 16. Note that it is also possible to adopt a constitution in which interior layer 2c is not a single layer but is two or more layers.

Surface layer 2b is formed from rubber having a rebound resilience of 35% to 40%. As a result, because surface layer 2b is formed from rubber that will cause reduction in roiling resistance, it is possible to reduce the rolling resistance of tire 1. Note that rebound resilience is rebound resilience as measure data temperature of 23° C. during Rüpke rebound resilience testing carried out in accordance with JIS K 6255. Furthermore, there is no particular limitation with respect to the rebound resilience of the rubber that forms interior layer 2c.

Present at tread surface 2a is the ground contact surface that actually comes in contact with the road surface, and the portions within said ground contact surface that are present at the outer ends in the tire width direction D1 are referred to as grounding ends 2d, 2d. Note that said ground contact surf ace refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface.

Normal rim 20 is that particular rim which is specified for use with a particular tire 1 in the context of the body of standards that contains the standard that applies to the tire 1 in question, this being referred to, for example, as a standard rim in the case of JATMA, a design rim in the case of TRA, or a measuring rim in the case of ETRTO.

Normal internal pressure is that air pressure which is specified for use with a particular tire 1 in the context of the body of standards that contains the standard that applies to the tire 1 in question, this being “maximum air pressure” in the case of JATMA, the maximum value listed at the table entitled “Tire Load Limits at Various Cold Inflation Pressures” in the case of TRA, or “inflation pressure” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being “maximum load capacity” in the case of JATMA, the maximum value listed at the aforementioned table in the case of TRA, or “load capacity” in the case of ETRTO, which when tire 1 is to be used on a passenger vehicle is taken to be 85% of the load corresponding to an internal pressure of 180 KPa.

Tire 1 has a structure that is asymmetric with respect to tire equatorial plane S1. Such a tire 1 is a tire for which a vehicle mounting direction is indicated, which is to say that there is an indication of whether the left or the right side of the tire should be made to face the vehicle when tire 1 mounted on rim 20. Moreover, the tread pattern formed at the tire exterior surface at tread region 13 is asymmetric with respect to tire equatorial plane S1. The orientation in which the tire is to be mounted on the vehicle is indicated at sidewall region 12. More specifically, sidewall region 12 has an indicator region (not shown) at the tire exterior surface.

In accordance with the present embodiment, one sidewall region 12, i.e., that which is to be arranged toward the inboard side (left side at the drawings; hereinafter also referred to as “vehicle inboard side”) of the mounted tire, is marked (e.g., with the word “INSIDE” or the like) so as to contain an indication to the effect that it is for the vehicle inboard side; while the other sidewall region 12, i.e., that which is to be arranged toward the outboard side (right side at FIG. 1; hereinafter also referred to as “vehicle outboard side”) of the mounted tire, is marked (e.g., with the word “OUTSIDE” or the like) so as to contain an indication to the effect that it is for the vehicle outboard side.

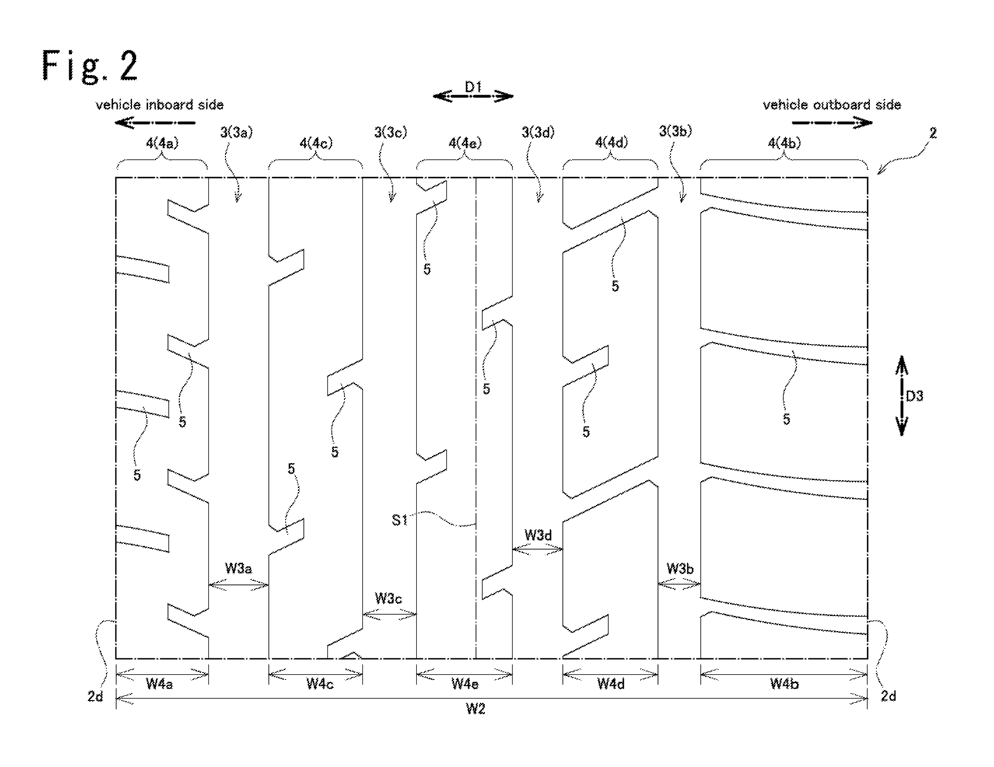

As shown in FIG. 1 and FIG. 2, tread rubber 2 is provided with a plurality of main grooves 3 (3a through 3d) extending in the tire circumferential direction D3. Main groove 3 extends continuously in the tire circumferential direction D3. Main groove 3 might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3 might, for example, have a width that is not less than 3% of the distance (dimension in the tire width direction D1) W2 between grounding ends 2d, 2d. Furthermore, main groove 3 might, for example, have a width that is not less than 5 mm.

Furthermore, at the plurality of main grooves 3, the pair of main grooves 3a, 3b arranged at outermost locations in the tire width direction D1 are referred to as shoulder main grooves 3a 3b, and the main groove(s) 3c, 3d arranged between the pair of shoulder main grooves 3a, 3b are referred to as center main groove(s) 3c, 3d. In the present embodiment, the number of center main groove(s) 3c, 3d that are present is two.

Of the shoulder main grooves 3a, 3b, that shoulder main groove 3a which is arranged toward the vehicle inboard side is referred to as inboard shoulder main groove 3a, and that shoulder main groove 3b which is arranged toward the vehicle outboard side is referred to as outboard shoulder main groove 3b. Of the center main grooves 3c, 3d, that center main groove 3c which is arranged toward the vehicle inboard side is referred to as inboard center main groove 3c, and that center main groove 3d which is arranged toward the vehicle outboard side is referred to as outboard center main groove 3d.

Tread rubber 2 is provided v/ith a plurality of land portions 4 (4a through 4c) which are partitioned by main grooves 3 and grounding ends 2d. In the present embodiment, because the number of main groove(s) 3 that are present is four, the number of land portion(s) 4 that are present is five.

At the plurality of land portions 4, land portion(s) 4a, 4b which are partitioned by shoulder main groove(s) 3a, 3d and grounding end(s) 2d are referred to as shoulder land portion(s) 4a, 4b. Furthermore, land portion(s) 4c, 4d which are par titioned by shoulder main groove(s) 3a, 3b and center main groove(s) 3c, 3d are referred to as mediate land portion(s) 4c, 4d, and land port ion 4e which are part it ioned by the pai r of center main grooves 3c, 3d are referred to as center land portion 4e.

Of the shoulder land portions 4a, 4b, that shoulder land portion 4a which is arranged toward the vehicle inboard side is referred to as inboard shoulder land portion 4a, and that shoulder land portion 4b which is arranged toward the vehicle outboard side is referred to as outboard shoulder land portion 4b. Furthermore, of the mediate land portions 4c, 4d, mediate land portion(s) 4c arranged toward the vehicle inboard side are referred to as inboard mediate land portion 4c, and mediate land portion(s) 4d arranged toward the vehicle outboard side are referred to as outboard mediate land portion 4d.

Land portion 4 is provided with a plurality of land grooves 5. Land grooves 5 extend so as to intersect the tire circumferential direction D3. Note that land groove(s) 5 include narrow concavity or concavities such as those referred to as sipe(s). Furthermore, land groove(s) 5 include groove(s) that are narrower than main groove(s) 3 and that extend continuously along the tire circumferential direction D3, and/or groove(s) which extend intermittently in the tire circumferential direction D3.

Next, aspects of the constitution that is characteristic of tire 1 associated with the present embodiment, as well as actions and effects thereof, will be described.

(1) While it is possible to lower rolling resistance because the rubber that forms surface layer 2b has a rebound resilience of 35% to 40%, there is a tendency for the rigidity of land portion(s) 4 to decrease. As a result, there is concern that there could be decrease in cornering power, causing reduction in performance with respect to stability in handling during turns.

Width (the dimension in the tire width direction D1) W4b of outboard shoulder land portion 4b arranged in outboardmost fashion on the mounted tire is therefore made larger than widths (the dimensions in the tire width direction D1) W4a and W4c through W4e of the other land portions 4a and 4c through 4e. In addition, it is preferred that the area of outboard shoulder land portion 4b (including land groove(s) 5) be not less than 20% of the total area of all land portions 4 (including land groove(s) 5).

As a result, because outboard shoulder land portion 4b will be of adequate size, this will make it possible to suppress reduction in rigidity at outboard shoulder land portion 4b. Because this will make it possible to suppress decrease in cornering power, it will therefore make it possible to suppress reduction in performance with respect to stability in handling during turns.

(2) But, during driving, the amount of elastic deformation at shoulder land portion 4a, 4b will be greater than the amount of elastic deformation at either mediate land portion 4c, 4d or center land portion 4e. As a result, the energy loss at shoulder land portion 4a, 4b will be greater than the energy loss at either mediate land portion 4c, 4d or center land portion 4e.

It is therefore preferred that the area of outboard shoulder land portion 4b be not greater than 25% of the total area of all land portions 4. Where this is the case, because it will be possible to prevent a situation in which the size of outboard shoulder land portion 4b becomes too large, this will make it possible to suppress increase in energy loss at outboard shoulder land portion 4b. This will therefore make it possible to suppress increase in rolling resistance.

(3) Furthermore, it is preferred that surface layer 2b be formed from rubber having a hardness that is not less than 60. This will make it possible to suppress reduction in rigidity at land portion 4. Note that hardness is hardness as measured at 23° C. using a durometer hardness test apparatus (Type A) in accordance with JIS K 6253. Moreover, causing surface layer 2b to be formed from rubber having a hardness that is not greater than 65 will permit actions and effects of the constitution having the foregoing and the following characteristic aspects to be exhibited in marked fashion. Furthermore, there is no particular limitation with respect to the hardness of the rubber that forms interior layer 2c.

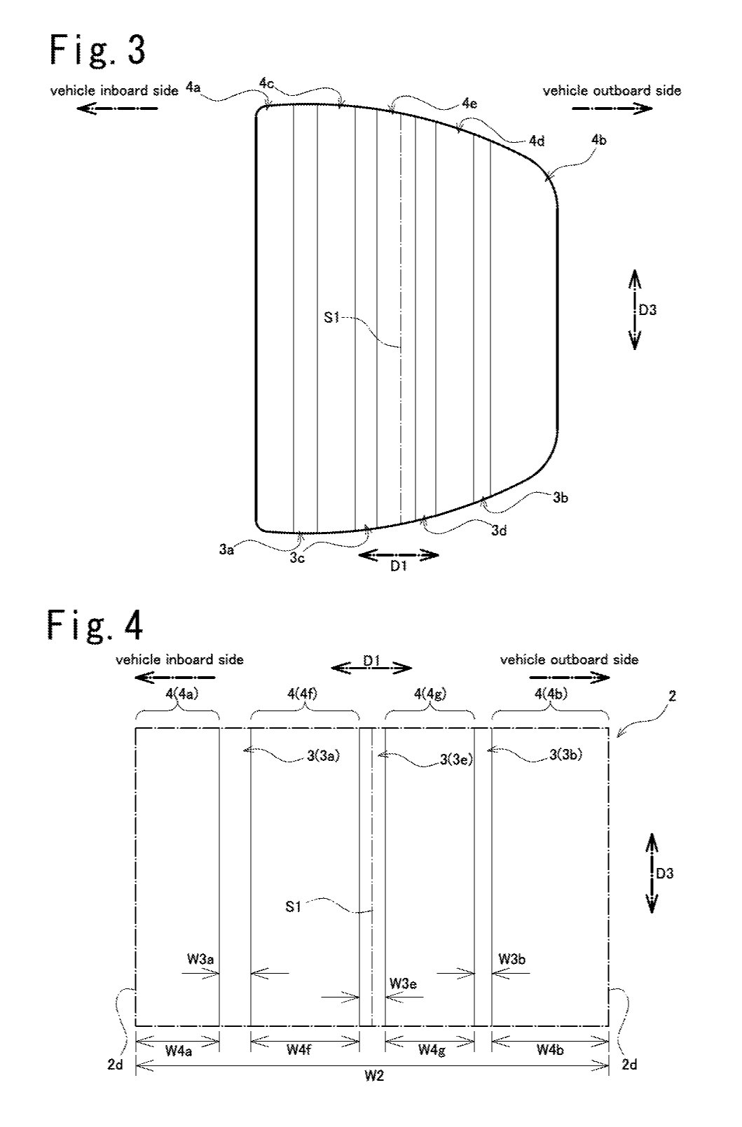

(4) But when tire 1 is mounted on a vehicle in such fashion as to have negative camber, it will be inclined in such a direction as to cause it to be directed from the outboard side of the vehicle to the inboard side of the vehicle as one proceeds from the bottom thereof to the top thereof. As a result, the ground contact shape when driving straight, ahead (see FIG. 3; note that land groove(s) 5 are not shown at FIG. 3) will be such that ground contact length (length in the tire circumferential direction D3) at the vehicle inboard side is greater than ground contact length at the vehicle outboard side. Accordingly, there is a tendency for accumulation of water to occur at inboard shoulder main groove 3a and inboard center main groove 3c, which are arranged to the vehicle inboard side of tire equatorial plane S1.

The total area of inboard shoulder main groove 3a and inboard center main groove 3c, which are arranged to the vehicle inboard side of tire equatorial plane SI, is therefore made larger than the total area of outboard shoulder main groove 3b and outboard center main groove 3d, which are arranged to the vehicle outboard side of tire equatorial plane S1. In addition, it is preferred that the total area of the former, i.e., those toward the vehicle inboard side, be 101% to 115% of the total area of the latter, i.e., those toward the vehicle outboard side. As a result, because it will foe possible to suppress the tendency for water to accumulate toward the vehicle inboard side, this will make it possible to suppress decrease in anti-hydroplaning performance.

Furthermore, width W3a of inboard shoulder main groove 3a is made larger than width W3c of inboard center main groove 3c, and width W3c of inboard center main groove 3c is made larger than width W3d of outboard center main groove 3d. Moreover, width W3d of outboard center main groove 3d is made larger than width W3b of outboard shoulder main groove 3b.

This being the case, ground contact length tends to be greater the further that a location is toward the vehicle inboard side, for which reason main grooves 3a through 3d are made to be such that the further toward the vehicle inboard side at which a main groove 3a, 3c, 3d, 3b is located the greater is the width W3a through W3a thereof. Where this is the case, because it will be possible to suppress the tendency for water to accumulate at main groove(s) 3, this will make it possible to suppress decrease in anti-hydroplaning performance.

Moreover, width W4a of inboard shoulder land portion 4a is made less than widths W4b through W4e of the other land portions 4b through 4e. In addition, it is preferred that width W4a of inboard shoulder land portion 4a be not greater than 25% of distance W2 between grounding ends 2d, 2d.

Where this is the case, because inboard shoulder main groove 3a will not be separated from grounding end 2d but will be arranged at a location at which ground contact length is large, it will be possible to increase the efficiency with which water shedding attributable to inboard shoulder main groove 3a is carried out. Moreover, to prevent occurrence of a situation in which rigidity of inboard shoulder land portion 4a is reduced too much, it is preferred that width W4a of inboard shoulder land portion 4a be not iess than 10% of distance W2 between grounding ends 2d, 2d.

Moreover, it is preferred that the void ratio between grounding ends 2d, 2d at tread surface 2a be not less than 30%. Where this is the case, because it will be possible, by prevent ing occurrence of a situation in which the void ratio is too low, to cause water shedding to occur in appropriate fashion, this will make it possible to suppress decrease in anti-hydroplaning performance. Note that void ratio is the ratio of groove area (the sum of the area of main groove(s) 3 and the area of land groove(s) 5) to ground contact area (the sum of the area of main groove(s) 3 and the area of land portion(s) 4 (including land groove(s) 5)) that is the area between grounding ends 2d, 2d.

In addition, it is preferred that the void ratio attributable to main groove(s) 3 between grounding ends 2d, 2d at tread surface 2a be not less than 20%. Where this is the case, because it will be possible for main groove(s) 3 to carry out water shedding in appropriate fashion, this will make it possible to suppress decrease in ant.i-hydroplaning performance. Note that the void ratio attributable to main groove(s) 3 is the ratio of the area of main groove(s) 3 to the area of the ground contact.

(5) But if the void ratio becomes too large, this will cause decrease in rigidity at land portion(s) 4. It is therefore preferred that the void ratio between grounding ends 2d, 2d at tread surface 2a be not greater than 40%. In addition, it is preferred that the void ratio attributable to main groove(s) 3 between grounding ends 2d, 2d at tread surface 2a be not. greater than 30%. This will make it possible to suppress reduction in rigidity at land portion(s) 4.

Furthermore, it is preferred that the void ratio attributable to land groove(s) 5 between grounding ends 2d, 2d at tread surface 2a be not greater than 10%. This will make it possible to suppress reduction in rigidity at land portion(s) 4. Note that the void ratio attributable to land groove(s) 5 is the ratio of the area of land groove(s) 5 to the area of the ground contact.

As described above, the pneumatic tire 1 of the embodiment include a tread region 13 having surface layer 2b containing a tread surface 2a that contacts the ground, and a sidewall region (12) having an indicator region that indicates a vehicle mounting direction, wherein the surface layer 2b is formed from rubber having a rebound resilience that is 35% to 40%, wherein the tread region 13 comprises a plurality of main grooves 3 that extend in a tire circumferential direction D3, and wherein total area of that portion of the main grooves 3a, 3c which is or are arranged to an inboard side of a center S1 in a tire width direction D1 of the tire as it is to be mounted on a vehicle is greater than total area of that portion of the main grooves 3b, 3d which is or are arranged to an outboard side of the center S1 in the tire width direction D1 of the tire as it is to be mounted on the vehicle.

In accordance with such constitution, that portion of tread region 13 which corresponds to surface layer 2b and contains the tread surface 2a that comes in contact with the ground is formed from rubber having a rebound resilience of 35% to 40%. Where this is the case, the rubber employed at surface layer 2b will be rubber that will cause reduction in rolling resistance.

But when pneumatic tire 1 is mounted on a vehicle in such fashion as to have negative camber, ground contact length at locations toward the inboard side of the mounted tire will be greater than ground contact length at locations toward the outboard side of the mounted tire. Accordingly, there is a tendency for accumulation of water to occur at locations toward the inboard side of the mounted tire.

The total area of main grooves 3a, 3c arranged to the inboard side of center SI in the tire width direction D1 of the mounted tire is therefore made larger than the total area of main grooves 3b, 3d arranged to the outboard side of center S1 in the tire width direction D1 of the mounted tire. Where this is the case, because it will be possible to suppress the tendency for water to accumulate at main groove(s) 3a, 3c arranged toward the inboard side at the mounted tire, this will make it possible to suppress decrease in anti-hydroplaning performance.

In the pneumatic tire 1 of the embodiment, wherein the further toward the inboard side that each of the plurality of main grooves 3a, 3c, 3d, 3b is arranged on the tire as it is to be mounted on the vehicle the greater is the width W3a through W3d of the each of the plurality of main grooves 3a through 3d.

In accordance with such constitution, ground contact length will tend to be greater the further that a location is toward the inboard side of the mounted tire, for which reason main grooves 3a through 3d are made to be such that the further toward the inboard side of the mounted tire at which a main groove 3a, 3c, 3d, 3b is located the greater is the width W3a through W3d thereof. This makes it possible to suppress the tendency for water to accumulate at main groove(s) 3.

In the pneumatic tire 1 of the embodiment, wherein the tread region 13 further comprises a plurality of land portions 4 that are partitioned by the plurality of main grooves 3 and grounding ends 2d, and wherein width W4b of that one 4b among the plurality of land portions 4 which is arranged in outboardmost fashion on the tire as it is to be mounted on the vehicle is greater than widths W4a and W4c through W4e of the other land portions 4a and 4c through 4e.

In accordance with such constitution, causing this to be formed from rubber having a rebound resilience of 35% to 40% results in a situation in which there is a tendency for rigidity at land portion(s) 4 to decrease, for which reason width W4b of land portion 4b arranged in outboardmost fashion on the mounted tire is made greater than widths W4a and W4c through W4e of the other land portions 4a and 4c through 4e. This makes it possible to suppress decrease in rigidity of land portion 4b arranged in outboardmost fashion on the mounted tire.

In the pneumatic tire 1 of the embodiment, wherein the tread region 13 further comprises a plurality of land portions 4 that are partitioned by the plurality of main grooves 3 and grounding ends 2d, and wherein width W4a of that one 4a among the plurality of land portions 4 which is arranged in inboardraost fashion on the tire as it is to be mounted on the vehicle is less than widths W4b through W4e of the other land portions 4b through 4e.

In accordance with such constitution, ground contact length will tend to be greater the further that a location is toward the inboard side of the mounted tire, for which reason width W4a of land portion 4a arranged in inboardmost fashion on the mounted tire is made less than widths W4b through W4e of the other land portions 4b through 4e. This being the case, main groove 3a arranged in inboardmost fashion on the mounted tire will not be too far from grounding end 2d but will be arranged at a location at which ground contact length is large.

In the pneumatic tire 1 of the embodiment, wherein the tread region 13 further comprises an inboard shoulder land portion 4a that is partitioned by a grounding end 2d and that one main groove 3a among the plurality of main grooves 4 which is arranged in inboardmost fashion on the tire as it is to be mounted on the vehicle, and an outboard shoulder land portion 4b that is partitioned by the grounding ends 2d and that one main groove 3b among the plurality of main grooves 3 which s: arranged in outboardmost fashion on the tire as it is to be mounted on the vehicle, and wherein width W4b of the outboard shoulder land portion 4b is greater than width W4a of the inboard shoulder land portion 4a.

In accordance with such constitution, because width W4b of outboard shoulder land portion 4b is made greater than width W4a of inboard shoulder land porti on 4a, it is possible to suppress occurrence of a situation in which width W4h of outboard shoulder land portion 4b becomes too small . This makes it possible to suppress decrease in rigidity of outboard shoulder land portion 4b.

What is more, because occurrence of a situation in which width W4a of inboard shoulder land portion 4a becomes too large is suppressed, this rakes it possible to suppress a situation in which main groove 3a arranged in inboardmost fashion on the mounted tire is too far from grounding end 2d. Accordingly, main groove 3a arranged in inboardraost fashion on the mounted tire will be arranged at a location at which ground contact length is large.

The pneumatic tire 1 is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that the number of main grooves 3 that are present is four. However, pneumatic tire 1 is not limited to such constitution. For example, it is also possible to adopt a constitution in which the number of main grooves 3 that are present is two or is five or more, and as shown in FIG. 4 it is also possible to adopt a constitution in which the number of main grooves 3 that are present is three.

Below, the constitution of pneumatic tire 1 associated with FIG. 4 is described. At FIG. 4, note that land grooves 5 are not shown.

At FIG. 4, because the number of main grooves 3 that are present is three/ the number of land portions 4 that are present is four. At the plurality of land portions 4, each land portion 4a, 4b which is partitioned by each shoulder main groove 3a, 3b and grounding end 2d is referred to as shoulder land portion 4a, 4b, and land portion 4f, 4g which is partitioned by each shoulder main groove 3a, 3b and center main groove 3e is referred to as center land portion 4f, 4g.

Of the shoulder land portions 4a, 4b, that shoulder land portion 4a which is arranged toward the vehicle inboard side is referred to as inboard shoulder land portion 4a, and that shoulder land portion 4b which is arranged toward the vehicle outboard side is referred to as outboard shoulder land portion 4b. Furthermore, of the center land portion(s) 4f, 4g, that center land portion 4f which is arranged toward the vehicle inboard side is referred to as inboard center land portion 4f, and that center land portion 4g which is arranged toward the vehicle outboard side is referred to as outboard center land portion 4g.

In addition, the total area of inboard shoulder main groove 3a, which is arranged to the vehicle inboard side of tire equatorial plane S1, is made larger than the tota 1 a rea of outboard shoulder main groove 3b, which is arranged to the vehicle outboard side of tire equatorial plane S1. This makes it possible to suppress the tendency for water to accumulate at locations toward the vehicle inboard side. Note that center main groove 3e which intersects tire equatorial plane S1 is not included among the main grooves arranged to the outboard side (or inboard side) of center S1 in the tire width direction D1 of the mounted tire.

Furthermore, width W3a of inboard shoulder main groove 3a is made larger than width W3e of center main groove 3e, and width W3e of center main groove 3e is made larger than width W3b of outboard shoulder main groove 3b. As a result, main grooves 3a, 3b, 3e will be such that the further toward the inboard side of the mounted tire at which the main groove 3a, 3e, 3b is arranged the greater will be the width W3a, W3b, W3e thereof. This makes it possible to suppress the tendency for water to accumulate at main groove(s) 3.

Width W4b of outboard shoulder land portion 4b arranged in outboardmost fashion on the mounted tire is larger than width W4a of inboard shoulder land portion 4a arranged in inboardmost fashion on the mounted tire. This being the case, inboard shoulder main groove 3a arranged in inboardmost fashion on the mounted tire will not be too far from grounding end 2d but will be arranged at a location at whichground contact length is large. Furthermore, because it will be possible to prevent a situation in which width W4b of outboard shoulder land portion 4b is too small, this makes it possible to suppress decrease in rigidity at outboard shoulder land portion 4b.

Moreover, width W4b of outboard shoulder land portion 4b arranged in outboardmost fashion on the mounted tire is made greater than widths W4a, W4e of other land portions 4a, 4e. Furthermore, width W4a of inboard shoulder land portion 4a arranged in inboardmost. fashion on the mounted tire is made smaller than widths W4b, W4e of other land portions 4b, 4e.

In addition, it is preferred that the area of outboard shoulder land portion 4b be not less than 25% of the total area of all land portions 4. Where this is the case, because it will be possible to prevent a situation in which the size of outboard shoulder land portion 4b becomes too small, this will make it possible to suppress decrease in rigidity at outboard shoulder land portion 4b. On the other hand, it is preferred that the area of outboard shoulder land portion 4b be not greater than 30% of the total area of all land portions 4. Where this is the case, because it will be possible to prevent a situation in which the size of outboard shoulder land portion 4b becomes too large, this will make it possible to suppress increase in energy loss at outboard shoulder land portion 4b.

Furthermore, it is preferred that the void ratio between grounding ends 2d, 2d at tread surface 2a be not less than 30%. Where this is the case, because it will be possible to prevent occurrence of a situation in which the void ratio is too low, this will make it possible to cause water shedding to occur in appropriate fashion. On the other hand, it is preferred that the void ratio between grounding ends 2d, 2d at tread surface 2a be not greater than 40%. Where this is the case, because it will be possible to prevent occurrence of a situation in which the void ratio is too high, this will make it possible to suppress decrease in rigidity at land portion(s) 4.

(2) Furthermore, in accordance with the constitution of pneumatic tire 1 associated with the foregoing embodiment, main grooves 3a through 3d are such that the further toward the inboard side of the mounted tire at which the main groove 3a, 3c, 3d, 3b is arranged the greater is the width W3a through W3d thereof. While such constitution is preferred, pneumatic tire 1 is not limited to such constitution. For example, it is also possible to adopt a constitution in which main grooves 3a through 3d are such that the further toward the inboard side of the mounted tire at which the main groove 3a, 3c, 3d, 3b is arranged the smaller is the width W3a through W3d thereof. Moreover, in accordance with such constitution, the number of main groove(s) 3 arranged to the vehicle inboard side of tire equatorial plane 31 is greater than the number of main groove(s) arranged to the vehicle outboard side of tire equatorial plane S1.

(3) Furthermore, the constitution of pneumatic tire 1 associated with the foregoing embodiment is such that width W4b of land portion 4b arranged in outboardmost fashion on the mounted tire is greater than widths W4a and isl4c. through W4e of the other land portions 4a and 4c through 4e. While such constitution Is preferred, pneumatic tire I is not limited to such constitution. For example, it is also possible to adopt a constitution in which width W4b of land portion 4b arranged in outboardmost fashion on the mounted tire is less than widths W4a and W4c through W4e of the other land portions 4a and 4c through 4e.

(4) Furthermore, the constitution of pneumatic tire 1 associated with the foregoing embodiment is such that width W4a of land portion 4a arranged in inboardmost fashion on the mounted tire is less than widths W4b through W4e of the other land portions 4b through 4e. While such constitution is preferred, pneumatic tire I is not limited to such constitution. For example, it is also possible to adopt a constitution in which width W4a of land portion 4a arranged in inboarcimost fashion on the mounted tire is greater than widths W4b through W4e of the other land portions 4h through 4e.

(5) Furthermore, the constitution of pneumatic tire 1 associated with the foregoing embodiment is such that width W4b of outboard shoulder land portion 4b is greater than width W4a of inboard shoulder land portion 4a. While such constitution is preferred, pneumatic tire 1 is not limited to such constitution. For example, it is also possible to adopt a constitution in which width W4b of outboard shoulder lane portion 4b is less than width W4a of inboard shoulder land portion 4a.

(6) Furthermore, the cons t tion of pneumatic tire 1 associated with the foregoi g embodiment is such that main groove(s) 3 extend in parallel fashion with respect to the tire circumferential direction D3. However, pneumatic tire 1 is not limited to such constitution. For example, i. is also possible to adopt a constitution in which main groove(s) 3 extend in zigzag fashion along the tire circumferential direction D3.

(7) urt Iermore, the constitution of pneumatic tire 1 associated with the foregoing embodiment is such that width(s) W3a through W3d of main groove(s) 3a through 3d are the same at all locations in the tire circumferential direction D3. However, pneumatic tire 1 is not limited to such constitution For example, it is also possible to adopt a constitution in which width(s) W3a through W3d of main groove(s) 3a through 3d vary. In the context of such constitution, width(s) W3a through W3d of main groove(s) 3a through 3d are the average value(s) of width(s) W3a through W3d of main groove(s) 3a through 3d.

(8) Furthermore, the constitution of pneumatic tire 1 associated with the foregoing embodiment is such that width(s) W4a through W4e of land portion(s) 4a through 4e are the same at all locations in the tire circumferential direction D3. However, pneumatic tire 1 is not limited to such constitution. For example, it is also possible to adopt a constitution in which width(s) W4a through W4e of land portion(s) 4a through 4e vary. In the context of such constitution, width(s) W4a through W4e of land portion(s) 4a through 4e are the average value(s) of width(s) W4a through W4e of land portion(s) 4a through 4e.

### EXAMPLES

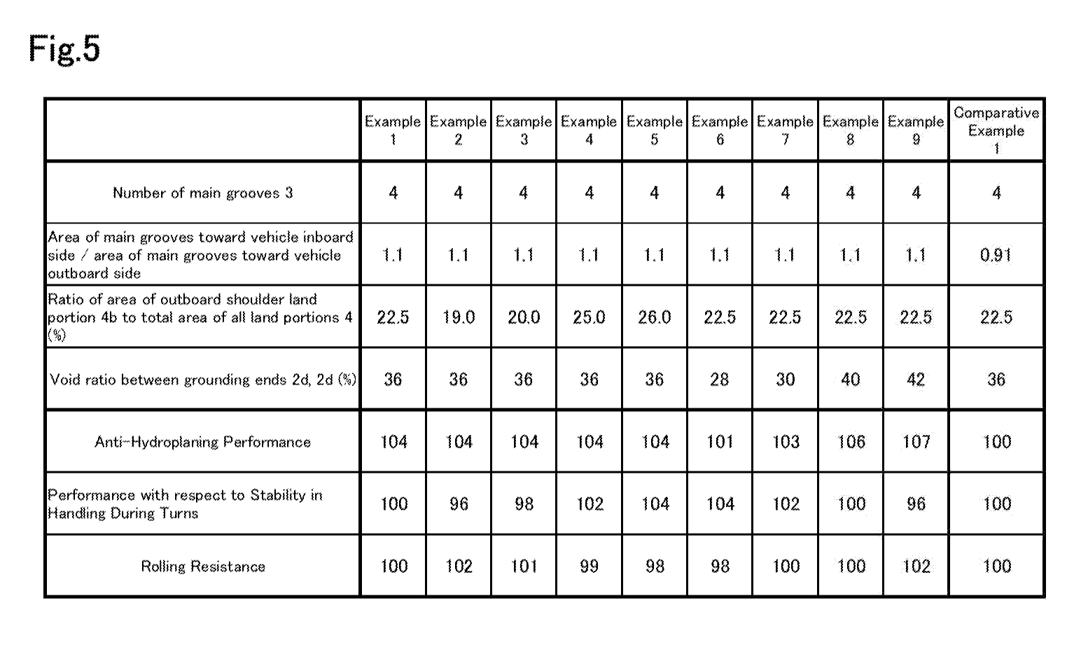

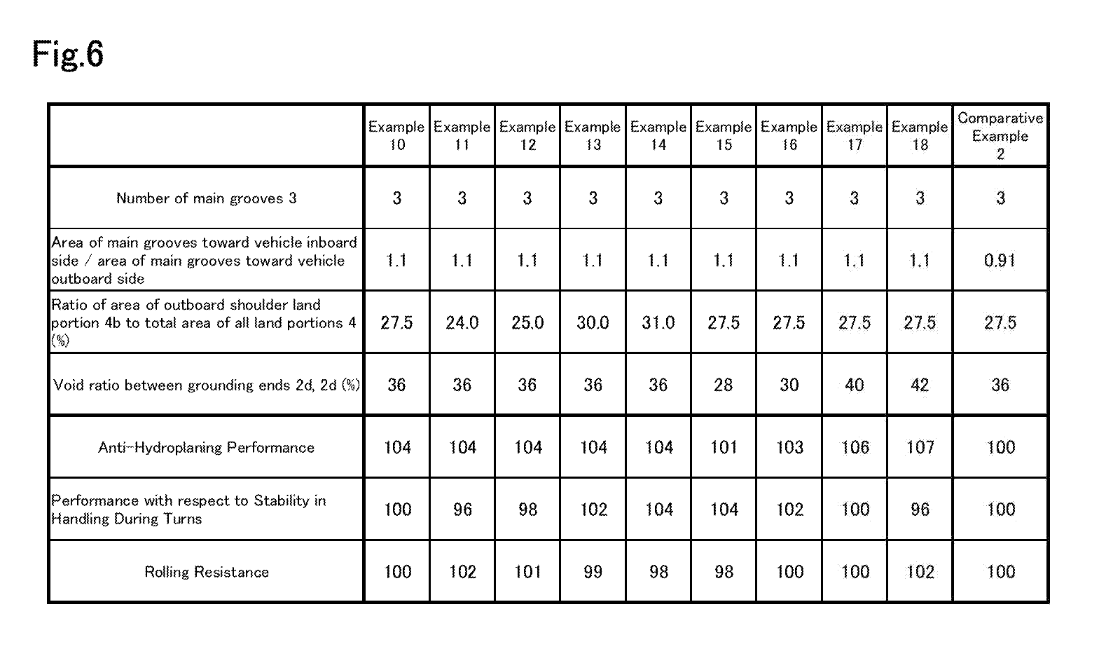

To illustrate the constitution and effect of tire 1 in specific terms, Examples of tire 1 as well as comparative examples thereof are described below with reference to FIG. 5 and FIG. 6.

<Anti-Hydroplaning Performance>

The respective tires were mounted on a vehicle, and with wheels on one side traveling straight ahead on a wet road for which water depth was 8 mm and wheels on the other side traveling straight ahead on a dry road, the speed necessary to cause the difference in percent slip between the left-side wheels and right-side wheels to reach 10% was measured. Results of evaluation are shown as indexed relative to a value of 100 for the comparative examples (Comparative Example 1 for Examples 1 through 9; Comparative Example 2 for Examples 10 through 18), the larger the index the less likely the tendency for hydroplaning to occur and the better the anti-hydroplaning performance.

<Performance with Respect to Stability in Handling During Turns>

The respective tires were mounted on a vehicle, and driving was carried out with turning on a dry road. In addition, sensory tests carried out by the driver were employed for the purpose of evaluating stability in handling. Results of evaluation are shown as indexed relative to a value of 100 for the comparative examples (Comparative Example 1 for Examples 1 through 9; Comparative Example 2 for Examples 10 through 18), the larger the index the better the stability in handling.

<Rolling Resistance>

After mounting the respective tires on rims, rolling resistance was measured in accordance with International Standard ISO 28580 (JIS D 4234). Results of evaluation are shown as indexed relative to a value of 100 for the comparative examples (Comparative Example 1 for Examples 1 through 9; Comparative Example 2 for Examples 10 through 18), the larger the index the lower, and better, the rolling resistance.

### Example 1

Example 1 was a tire which had the following constitution.

1) Number of main grooves 3=4

2) Rebound resilience (23° C.)=38%

3) Hardness (23° C.)=61

4) Total area of main grooves toward vehicle inboard side/total area of main grooves toward vehicle outboard side=1.1

5) Area of outboard shoulder land portion 4b/total area of all land portions 4=22.5%

6) Void ratio between grounding ends 2d, 2d at tread surface 2a=36%

7) Void ratio attributable to main grooves 3=29%

8) Void ratio attributable to land grooves 5=7%

### Example 2

Constitution of the tire of Example 2 was different from the constitution of tire i of Example 1 with respect to the following points.

5) Area of outboard shoulder land portion 4b/total area of all land portions 4=19.0%

### Example 3

Constitution of the tire of Example 3 was different from the constitution of tire 1 of Example 1 with respect to the following points.

5) Area of outboard shoulder land portion 4b/total area of all land portions 4=20.0%

### Example 4

Constitution of the tire of Example 4 was different from the constitution of tire 1 of Example 1 with respect to the following points.

5) Area of outboard shoulder land portion 4b/total area of all land portions 4=25.0%

### Example 5

Constitution of the tire of Example 5 was different from the constitution of tire 1 of Example 1 with respect to the following points.

5) Area of outboard shoulder land portion 4b/total area of all land portions 4=26.0%

### Example 6

Constitution of the tire of Example 6 was different from the constitution of tire 1 of Example 1 with respect to the following points.

6) Void ratio between grounding ends 2d, 2d at tread surface 2a=28%

7) Void ratio attributable to main grooves 3=24%

8) Void ratio attributable to land grooves 5−4%

### Example 7

Constitution of the tire of Example 7 was different from the constitution of tire 1 of Example 1 with respect to the following points.

6) Void ratio between grounding ends 2d, 2d at tread surface 2a=30%

7) Void ratio attributable to main grooves 3=25%

8) Void ratio attributable to land grooves 5=5%

### Example 8

Constitution of the tire of Example 8 was different from the constitution of tire 1 of Example 1 with respect to the following points.

6) Void ratio between grounding ends 2d, 2d at tread surface 2a=40%

7) Void ratio attributable to main grooves 3=30%

8) Void ratio attributable to land grooves 5=10%

### Example 9

Constitution of the tire of Example 9 was different from the constitution of tire 1 of Example 1 with respect to the following points.

6) Void ratio between grounding ends 2d, 2d at tread surface 2a=42%

7) Void ratio attributable to main grooves 3=31%

8) Void ratio attributable to land grooves 5=11%

### Comparative Example 1

Constitution of the tire of Comparative: Example 1 was different from the or of tire 1 of Example 1 with respect to the following points.

4) Total area of main grooves toward vehicle inboard side/total. area of main grooves toward vehicle outboard side=0.91 (=1/1.1)

### Example 1

Example 1 was a tire which had the following constitution.

1) Number of main grooves 3=4

2) Rebound resilience (23° C.)=38%

3) Hardness (23′ C.)=61

4) Total area of main grooves toward. vehicle inboard side/total. area of main grooves toward vehiole outboard side=1.1

5) Ratio of area of outboard shoulder laud portion 4b to total area of all land portions 4=22.5%

6) Void ratio between grounding ends 2d, 2d at tread surface 2a=36%

7) Void ratio attributable to main grooves 3=29%

8) Void ratio attributable to land grooves 5=7%

### Example 2

Constitution of the tire of Example 2 was different from the constitution of tire 1 of Example 1 with respect to the following points.

5) Ratio of area of outboard shoulder land portion 4b to total area of all land portions 4=19.0%

### Example 3

Constitution of the tire of Example 3 was different from the constitution of tire 1 of Example 1 with respect to the following points.

5) Ratio of area of outboard shoulder land portion 4b to total area of all land portions 4=20.0%

### Example 4

Constitution of the tire of Example 4 was different from the constitution of tire 1 of Example 1 with respect to the following points.

5) Ratio of area of outboard shoulder land portion 4b to total area of all land portions 4=25.0%

### Example 5

Constitution of the tire of Example 5 was different from the constitution of tire 1 of Example 1 with respect to the following points.

5) Ratio of area of outboard shoulder land portion 4b to total area of all land portions 4=26.0%

### Example 6

Constitution of the tire of Example 6 was different from the constitution of tire 1 of Example 1 with respect to the following points.

6) Void ratio between grounding ends 2d, 2d at tread surface 2a=28%

7) Void ratio attributable to main grooves 3=24%

8) Void ratio attributable to land grooves 5=4%

### Example 7

Constitution of the tire of Example 7 was different from the constitution of tire 1 of Example 1 with respect to the following points.

6) Void ratio between grounding ends 2d, 2d at tread surface 2a=30%

7) Void ratio attributable to main grooves 3=25%

8) Void ratio attributable to land grooves 5=5%

### Example 8

Constitution of the tire of Example 8 was different from the constitution of tire 1 of Example 1 with respect to the following points.

6) Void ratio between grounding ends 2d, 2d at tread surface 2a=40%

7) Void ratio attributable to main grooves 3=30%

8) Void ratio attributable to land grooves 5=10%

### Example 9

Constitution of the tire of Example 9 was different from the constitution of tire 1 of Example 1 with respect to the following points.

6) Void ratio between grounding ends 2d, 2d at tread surface 2a=42%

7) Void ratio attributable to main grooves 3=31%

8) Void ratio attributable to land grooves 5=11%

### Comparative Example 1

Constitution of the tire of Comparative Example 1 was different from the constitution of tire 1 of Example 1 with respect to the following points.

4) Total area of main grooves toward vehicle inboard side/total area of main grooves toward vehicle outboard side=0.91 (=1/1.1)

### Example 10

Example 10 was a tire which had the following constitution.

1) Number of main grooves 3=3

2) Rebound resilience (23° C.)=33%

3) Hardness (23° C.)=61

4) Total area of main grooves toward vehicle inboard side/total area of main grooves toward vehicle outboard side=1.1

5) Ratio of area of outboard shoulder land portion 4b to total area of all land portions 4=27.5%

6) Void ratio between grounding ends 2d, 2d at tread surface 2a=36%

7) Void ratio attributable to main grooves 3=29%

8) Void ratio attributable to land grooves 5=7%

### Example 11

Constitution of the tire of Example 11 was different from the constitution of tire 1 of Example 10 with respect to the following points.

5) Ratio of area of outboard shoulder land portion 4b to total area of all land portions 4=24.0%

### Example 12

Constitution of the tire of Example 12 was different from the constitution of tire 1 of Example 10 with respect to the following points.

5) Ratio of area of outboard shoulder land portion 4b to total area of all land portions 4=25.0%

### Example 13

Constitution of the tire of Example 13 was different from the constitution of tire 1 of Example 10 with respect to the following points.

5) Ratio of area of outboard shoulder land portion 4b to total area of all land portions 4=30.0%

### Example 14

Constitution of the tire of Example 14 was different from the constitution of tire 1 of Example 10 with respect to the following points.

5) Ratio of area of outboard shoulder land portion 4b to total area of all land portions 4=31.0%

### Example 15

Constitution of the tire of Example 15 was different from the constitution of tire 1 of Example 10 with respect to the following points.

6) Void ratio between grounding ends 2d, 2d at tread surface 2a=26%

7) Void ratio attributable to main grooves 3=24%

8) Void ratio attributable to land grooves 5=4%

### Example 16

Constitution of the tire of Example 16 was different from the constitution of tire 1 of Example 10 with respect to the following points.

6) Void ratio between grounding ends 2d, 2d at tread surface 2a=30%

7) Void ratio attributable to main grooves 3=25%

8) Void ratio attributable to land grooves 5=5%

### Example 17

Constitution of the tire of Example 17 was different from the constitution of tire 1 of Example 10 with respect to the following points.

6) Void ratio between grounding ends 2d, 2d at tread surface 2a=40%

7) Void ratio attributable to main grooves 3=30%

8) Void ratio attributable to land grooves 5=10%

### Example 18

Constitution of the tire of Example 18 was different from the constitution of tire 1 of Example 10 with respect to the following points.

6) Void ratio between grounding ends 2d, 2d at tread surface 2a=42%

7) Void ratio attributable to main grooves 3=31%

8) Void ratio attributable to land grooves 5=11%

### Comparative Example 2

Constitution of the tire of Comparative Example 2 was different from the constitution of tire 1 of Example 10 with respect to the following points.

4) Total area of main grooves toward vehicle inboard side/total area of main grooves toward vehicle outboard side=0.91 (=1/1.1)

<Results of Evaluation>

As shown in FIG. 5 and FIG. 6, anti-hydroplaning performance is greater than 100 at all of Examples 1 through 18. Accordingly, by causing the total area of main grooves, which is arranged to the vehicle inboard side, is made larger than the total area of main grooves, which is arranged to the vehicle outboard side, it was possible to suppress decrease in anti-hydroplaning performance while simultaneously employing rubber causing reduction in rolling resistance.

Furthermore, a preferred Example of a tire is described below.

Whereas the difference between rolling resistance and performance with respect to stability in handling during turns was 6 at Examples 2 and 5, the difference between rolling resistance and performance with respect to stability in handling during turns was 3 or less at Examples 1, 3, and 4. This being the case, it was more possible at Examples 1, 3, and 4 than at Examples 2 and 5 to simultaneously achieve satisfactory rolling resistance and performance with respect testability in handling during turns.

Accordingly, in the context of a constitution in which the number of main groove(s) 3 that are present is four, because it will be possible, by causing the area of outboard shoulder land portion 4b to be 20% to 25% of the total area of all land portions 4, to simultaneously achieve satisfactory roiling resistance and performance with respect to stability in handling during turns in even better fashion, this is preferred. It should be noted, of course, that tire 1 is not limited to such range.

Whereas the difference between rolling resistance and performance with respect to stability in handling during turns was 6 at Examples 6 and 9, the difference between rolling resistance and performance with respect to stability in handling during turns was 2 or less at Examples 1, 7, and 8. This being the case, it was more possible at Examples 1, 7, and 8 than at Examples 6 and 9 to simultaneously achieve satisfactory rolling resistance and performance with respect to stability in handling during turns.

Accordingly, in the context of a constitution in which the number of main groove(s) 3b that are present is four, because it will be possible, by causing the void ratio between grounding ends 2d, 2d at tread surface 2a to be 30% to 40%, to simultaneously achieve satisfactory rolling resistance and performance with respect to stability in handling during turns in even better fashion, this is preferred. It should be noted, of course, that tire 1 is not limited to such range.

Whereas the difference between rolling resistance and performance with respect to stability in handling during turns was 6 at Examples 11 and 14, the difference between rolling resistance and performance with respect to stability in handling during turns was 3 or less at Examples 10, 12, and 13. This being the case, it was more possible at Examples 10, 12, and 13 than at Examples 11 and 14 to simultaneously achieve satisfactory rolling resistance and performance with, respect to stability in handling during turns.

Accordingly, in the context of a constitution in which the number of main groove(s) 3 that are present is three, because it will be possible, by causing the area of outboard shoulder land portion 4b to be 25% to 30% of the total area of all land portions 4, to simultaneously achieve satisfactory rolling resistance and performance with respect to stability in handling during turns in even better fashion, this is preferred. It should be noted, of course, that tire 1 is not limited to such range.

Whereas the difference between rolling resistance and performance with respect to stability in handling during turns was 6 at Examples 15 and 18, the difference between rolling resistance and performance with respect testability in handling during turns was 2 or less at Examples 10, 16, and 17. This being the case, it was more possible at Examples 10, 16, and 17 than at Examples 15 and 18 to simultaneously achieve satisfactory rolling resistance and performance with respect to stability in handling during turns.

Accordingly, in the context of a constitution in which the number of main groove(s) 3 that are present is three, because it will be possible, by causing the void ratio between grounding ends 2d, 2d at tread surface 2a to be 30% to 40%, to simultaneously achieve satisfactory rolling resistance and performance with respect to stability in handling during turns in even better fashion, this is preferred. It should be noted, of course, that tire 1 is not limited to such range.

What is claimed is:

1. A pneumatic tire comprising:
a tread region having surface layer containing a tread surface that contacts the ground; and
a sidewall region having an indicator region that indicates a vehicle mounting direction;
wherein the surface layer is formed from rubber having a rebound resilience that is 35% to 40%;
wherein the tread region comprises a plurality of main grooves that extend in a tire circumferential direction; and
wherein total area of that portion of the main grooves which is or are arranged to an inboard side of a center in a tire width direction of the tire as it is to be mounted on a vehicle is greater than total area of that portion of the main grooves which is or are arranged to an outboard side of the center in the tire width direction of the tire as it is to be mounted on the vehicle.

2. The pneumatic tire according to claim 1
wherein the further toward the inboard side that each of the plurality of main grooves is arranged on the tire as it is to be mounted on the vehicle the greater is the width of the each of the plurality of main grooves.

3. The pneumatic tire according to claim 1
wherein the tread region further comprises a plurality of land portions that are partitioned by the plurality of main grooves and grounding ends; and
wherein width of that one among the plurality of land portions which is arranged in outboardmost fashion on the tire as it is to be mounted on the vehicle is greater than widths of the other land portions.

4. The pneumatic tire according to claim 1
wherein the tread region further comprises a plurality of land portions that are partitioned by the plurality of main grooves and grounding ends; and
wherein width of that one among the plurality of land portions which is arranged in inboardmost fashion on the tire as it is to be mounted on the vehicle is less than widths of the other land portions.

5. The pneumatic tire according to claim 1
wherein the tread region further comprises
an inboard shoulder land portion that is partitioned by a grounding end and that one main groove among the plurality of main grooves which is arranged in inboardmost fashion on the tire as it is to be mounted on the vehicle, and
an outboard shoulder land portion that is partitioned by the grounding ends and that one main groove among the plurality of main grooves which is arranged in outboardmost fashion on the tire as it is to be mounted on the vehicle; and
wherein width of the outboard shoulder land portion is greater than width of the inboard shoulder land portion.

6. The pneumatic tire according to claim 3
wherein there are four of the main grooves; and
wherein area of the one among the plurality of land port ions which is arranged in outboardmost fashion on the tire as it is to be mounted on the vehicle is 20% to 25% of total area of all of the land portions.

7. The pneumatic tire according to claim 3
wherein there are three of the main grooves; and
wherein area of the one among the plurality of land portions which is arranged in outboardmost fashion on the tire as it is to be mounted on the vehicle is 25% to 30% of total area of all of the land portions.

8. The pneumatic tire according to claim 1
wherein there are four of the main grooves; and
wherein void ratio between a pair of grounding ends is 30% to 40%.

9. The pneumatic tire according to claim 1
wherein thece are three of the main grooves; and
wherein void ratio between a pair of grounding ends is 30% to 40%.

10. The pneumatic tire according to claim 1
wherein hardness of the rubber of the surface layer is not less than 60.
